(19) United States
(12) Patent Application Publication
(10) Pub. No.: US 2009/0327051 A1
(43) Pub. Date: Dec. 31, 2009

(54) Online employee assessment and management performance system and method

(76) Inventor: Diane Nerby, Summit, NJ (US)

Correspondence Address: WARD & OLIVO, Suite 300, 382 Springfield Avenue, Summit, NJ, 07901, US

(21) Appl. No.: 10/678,048

(22) Filed: Oct. 2, 2003

(51) Int. Cl. G06Q 10/00; G06Q 99/00; G06F 17/30

(52) U.S. Cl. 705/11; 705/1; 705/7; 707/104.1; 707/E17.044

(57) ABSTRACT

The present invention is a novel online enterprise management system. The system facilitates communication and teamwork within an organization using real-time techniques. The system allows employees to easily assess themselves and their organization, and provide ideas for improving business. The results are compiled into one or more databases and available for personal, managerial or team review. Thus, managers can more readily understand their employees' strengths and needs, and thereby, provide an optimal work environment. Also, employees can share perspectives, and make unique contributions to the business or across organizations. In addition, the system may be used by managers to input their ideas to upper-level management, executives, and so forth. Also, the present invention provides data indicating the difference, or “gap,” between employees' desired state and actual state. Therefore, managers are able to motivate their employees by reducing this gap, improving productivity and overall performance.

### FIELD OF THE INVENTION

This invention relates generally to enterprise management systems, and in particular, to a process for optimizing management practices to benefit individuals and the organization, resulting in improved individual and collective performance. Furthermore, numerous employee querying, assessing, and goal setting methods are contemplated.

### BACKGROUND OF THE INVENTION

Business managers must consider a number of constantly changing factors to succeed in a modern and dynamic economic and political environment. These factors include globalization, technological advances, customer demands, and evolving regulations. Global competition has prompted the growth of services provided from countries overseas. The Internet has made traditional business processes almost obsolete by reducing costs, barriers to entry and time to market. Furthermore, the makeup of the workforce and the “average consumer” are changing at an accelerating rate due to an aging population and rapidly growing minority population. These factors are presenting new challenges and demand significant change from both organizations and individuals. Adapting and effectively dealing with these constantly changing factors can be a source of increased stress for both managers and employees.

Business organizations have tried to adapt to meet market needs through mergers and acquisitions, outsourcing, downsizing, and/or partnering. They are constantly reorganizing and trying new strategic directions. The demanding competition has led to high performance cultures that require people to be result oriented, fast and flexible.

At the same time, individuals have changed their attitude toward work. In an environment where massive layoffs are common, individuals have become more independent and frequent job or career switching is more common than ever. Most individuals are more demanding of personal growth opportunities and strive for a better balance between their professional and personal lives. The changing demographics have led to an increase of women and minorities in the workplace. In short, a new generation of workers with a different view of the world has emerged.

In response to these challenges, organizations are finding new ways to connect with their customers, their suppliers and their partners, relying on a “network” of suppliers, consultants, contractors, employees, customers and other partners to deliver business results. The Internet is enabling these organizations to develop an online network of relationships, creating “virtual enterprises” that transcend traditional organizational boundaries. The businesses that will be able to thrive in the future must follow this trend and begin transforming today. Information sharing, real time alignment and execution across the virtual enterprise will not be achieved with traditional tools.

However, while some businesses and individuals are modernizing, many organizations still operate under an old structure of management which was developed for a very different business environment. Old management processes focus on the concept of organizations (and therefore, managers) “taking” from their employees. During the days when Henry Ford was a manager, workers were considered easily interchangeable and expendable. Although this is an extreme view, many organizations still follow this old way of thinking; individuals are forced to conform to the structure and environment of their workplace. Under these conditions, employees are unable to communicate their goals and needs to managers. They have little say in decisions that effect the organization or their own jobs. In this strict “management knows all” framework, employees are more likely to feel like expendable commodities, because many of their valuable ideas are unsolicited, and ultimately unheard.

In addition, many of the traditional management practices are not tailored for a constantly changing environment. Employees are reviewed only on an annual or semi-annual basis, while the workforce changes constantly. Managers are taking on more responsibility without the skills or the time to do so. They have more people to manage along with their own careers, while at the same time trying to manage customers. Additionally, the goals of the organization are cascaded from the top down. By the time information is fully communicated, circumstances have probably changed and the information could be useless. Employees and employers are not working together as a team, so they only see things from their own perspective. Consequently, traditional management processes prevent managers from managing people and projects efficiently, and prevent businesses from advancing as quickly as possible.

Keeping up with the volatile business environment and twenty-first century mindset of the labor market requires an adjustment to the management process. The goals of individual employees can no longer be neglected. If they are, managers risk high turnover or the retention of unproductive and unmotivated employees. Individual employment expectations and the makeup of the workforce are evolving more rapidly than traditional processes are being abandoned or modified to effectively accommodate this new atmosphere.

The unfortunate results of the proliferation of these outdated practices are employees who are constantly looking for better job opportunities and businesses that are always looking for ways to improve the productivity of uninspired employees, to no avail. Businesses expect more from their employees than ever before, but forget that individual employees have their own (often unaddressed) goals and needs. Meanwhile, the job market and the economy continue to fluctuate, so the bargaining power between the two groups continually changes. In such circumstances, these two groups are prone to clash rather than sustain a symbiotic relationship. The outcome of this dilemma is that both the individual and the organization are working below their potential. Neither the organization nor the individual is able to focus their energy externally, while internal problems still exist. The increased workload, stress and lack of control felt by many individuals have left them disengaged and discouraged, hindering innovation and productivity. The result is a work environment of confusion, lack of focus, and underperformance. Inevitably, the business as a whole suffers and is unable to compete as effectively as if these problems did not exist.

Considering these dynamics, it is essential that both employers and employees find a way to redefine their relationship and effectively communicate their personal and business goals in an expedient and efficient manner. A new process of management and a new role for managers is necessary to fit the needs of both the individual and the organization. In the new business era, the old policies, procedures, methods and business models will no longer work. The new process must be geared toward retaining satisfied employees, increasing individual and organizational performance, and developing new mindsets focused on innovation and collaboration.

Numerous studies have revealed that job performance is tied not only to ability, but motivation. Ability is merely a measure of one's skills and qualifications. Ability is usually only improved by education, experience, and training. Consequently, efforts to improve ability can be tedious, and often fruitless. However, motivation relates to drive; the desire to perform a function. Motivation, unlike ability, can be easily improved. An employee's satisfaction at work is generally indicated by a gap between the employee's actual state (i.e., actual level of satisfaction regarding various aspects of employment) and desired state (total satisfaction regarding all aspects of employment). Obviously, employees prefer to keep this gap as narrow as possible and would likely be willing to work harder if they knew that extra effort would translate into a substantial shift toward their desired state. The intention of managers should be to reduce this gap using motivating factors. In other words, managers can induce employees, or motivate them, to meet business goals. However, in a modern environment where the employer is not always the one with the bargaining power, managers must know what is most important to their employees in order to motivate them. Considering time constraints, this is not an easy task, especially for managers who oversee a large number of employees.

Highly specific data must be ascertained in order to efficiently manage employees, but in order to maximize that efficiency, accurate data must be collected on the first attempt. Since each organization is unique in terms of location, demographic composition, labor supply and demand, culture, etc., managers must look internally for up-to-date information on their employees. Employees of some organizations may be primarily interested in their pay. In other organizations, employees may value benefits and cushy working conditions. A wide array of other attributes may also be valued by employees. Some examples include, but are not limited to, security, pride in the organization, opportunity for advancement, challenging tasks, etc.

Fred Luthans, an expert in the field of employee motivation, advocates the so-called “contingency approach.” He maintains that individuals respond differently to various managerial practices. Moreover, management techniques will also have varying effects on individuals depending on job function. Under this theory, managers must adapt their leadership styles for a particular employee or team and a specific job.

Victor Vroom, another human resources expert, professes his “expectancy theory,” an extension of the “contingency approach.” Consonant with Luthans' approach, leadership style should be “tailored” for particular groups. In some cases it is optimal for the manager to make decisions, and in others it is ideal for the group to lead. Also, individuals should be rewarded with what they find important rather than what managers perceive as important. In short, this theory hinges on how an individual's goals and values influence that individual's performance. Thus, managers must collect data to determine what is most important to their employees in order to see improved results.

There are an abundance of programs and tools available from quality practices, e-learning programs, leadership development efforts, etc., geared toward improving worker productivity. However, these tools and processes have had only a short term, limited impact on overall productivity.

In a complex environment where individuals and organizations are continually changing, employee input is essential for determining needs and goals. In order to obtain this data and ascertain what employees want, constant communication is also essential.

However, fostering communication between managers and employees is often a difficult task. Managers and employers are often dealing with time constraints, and taking time to coddle employees and learn about their needs often seems counter productive, because it takes time away from actual production. It follows that employees remain unmotivated because their needs are not being met, therefore productivity slows, yet employers continue to neglect the needs of their employees because it would seemingly take too much time away from productivity to do so. Clearly savvy employers understand this vicious circle and the need to break it. However, the traditional tools for learning about employees (such as face-to-face reviews and interviews) take too much time to execute.

Thus, managers are in need of a communication tool that allows them to proactively engage and motivate employees according to individual values. Therefore, an increasing need exists for systems that effectively communicate the needs and goals of employees to their respective managers. Preferably, such a system may also include methods that encourage employees to define individual personal and company goals. Managers can then use this information to tailor the work environment to these goals, thereby improving it for individual employees, which should in turn optimize productivity.

When designing such a system, a study conducted by management expert Walter Mahler surveying over 5,000 managers may be considered. The study found that prior to their promotion to managers, almost half had never received performance reviews; 44 percent had never been told the requirements for higher-level jobs; and 31 percent had never been encouraged by their superiors to take specific actions to prepare for advancement. Mahler argues that such discussion and preparation are essential for employee motivation to advance and overall company improvement.

One type of communication system which facilitates such discussion is periodic employee assessments. Typically, an employee is required to meet with one or more managers in person to discuss and record individual and company goals. The manager(s) then give the employee a performance-based assessment and suggestions for improvement. This method, however, is time-consuming and ineffective for certain types of employees. Moreover, this form of communication is confrontational, requires planning, and is subject to flawed appraisals. One possible cause of flaws is managers' tendency to avoid extreme assessments. Subordinates given an extremely high rating may expect immediate rewards or seek them elsewhere. Those given a very low rating may become indignant or lose the desire to perform. Additionally, assessments may be biased by manager-employee relationships. In general, these assessments often inhibit openness and honesty between managers and employers. Therefore, they may prove fruitless for improving an organization's work environment.

One possible solution to the pitfalls of a management assessment is self-appraisal reviews. Generally, these involve a methodical and comprehensive analysis of past performance and development of a plan for self-improvement. These reviews often cover aspects of the employees' job as well as the companies' goals. Usually, employees are provided with a questionnaire, allowing them to assess their own performance and define their future goals. The employees may continually review and follow up on the activities that need improvement. Improvements proposed by the questionnaire may include more frequent reporting to one's superior, taking a brush-up course in some aspect of a job, learning to submit expense reports more promptly, etc.

Typically, managers do not intervene with the self evaluation process. Of course, it would be beneficial for the manager to review the employee's self-assessment, but that usually is not required. Therefore, the self-appraisal process, though efficient, does not necessarily inform managers of the goals and ideals of their employees. Even if managers did decide to take a proactive role and review their employees' self-appraisals, they would have no easy way to compile the written information. Inevitably, analyzing information thoroughly enough to effect real change would be too tedious and time consuming. Thus, managers are not able to make use of the information and employees see little of the desired results. In sum, this process does not provide an efficient means to manage enterprise organizations.

The design of enterprise management systems should also attend to socioeconomic considerations. For instance, the continual increase in computer literacy introduces many opportunities for innovative products. Numerous methods and devices previously used independent of computers have been adapted or integrated for use with computer systems. Computers have made communicating, storing, and transferring information simpler, faster, and more accurate. In addition, the constantly changing work conditions and work force demographics require a system that can be continuously updated and reviewed without delay. Thus, a real-time computer-based self-appraisal system would expedite compilation of information provided by employees. Further, a web-based online system would increase accessibility to a wide range of employees, reduces the amount of time required to conduct self-appraisals, reduce opportunities for bias, and eliminate confrontation. Moreover, a well-organized computer based self-appraisal system would provide employees with an efficient and effective method of defining their goals, learning what they need from work, articulating their needs, and focusing on development of important skills. Additionally, this information could be effortlessly communicated to managers, which will allow managers to have a more systematic way of ascertaining employees' needs and their ideas relating to an improved work environment. Managers would be able to access what they need when they want it, and more effectively manipulate data to be viewed for analysis. Further, this system could be designed to focus on information sharing and combining perspectives, collaboration and creating alignment focused on the customer and delivering business results.

Thus, a real-time “electronic” self appraisal and collaboration system that facilitates communication and understanding of employees' desires and needs is becoming increasingly necessary in today's business climate. Not only would management benefit from such a system, employees could also more easily define and address issues critical to their own success. Once they understand and articulate their own goals, they can use this system for contributing to the organization and improving performance. For such a system to carry out its desired functions, the system must have the ability to quickly, effectively, and accurately communicate this information to management without significantly disrupting an organization's workflow and productivity. Such a system is disclosed in the present invention.

There is a clear need for a system that provides an efficient method for employees to input their goals and ideas for managerial analysis, as well as assess themselves through evaluation and performance tools, in a timely and efficient manner. The present invention is designed to fulfill a unique set of goals. It provides a self-appraisal process and system for optimizing communication between employees and managers, managers and executives, and members of a team. It incorporates a real-time online computer system with the ability to assist employees in defining personal goals and planning to achieve them. Consequently, the system addresses employee appraisal issues for various job functions. Further, the system of the present invention creates a database of employee input for managerial use. The improved system provides managers with the ability to review employees' personal and company goals. Therefore, employees can effectively communicate their thoughts about the work environment and business performance to management. In return, managers can efficiently access data, learn how to better motivate employees, and help employees to be more successful. Moreover, the present invention provides a system that permits employees to assess their performance and convey their unique personal and company goals to management through questionnaires. Alternatively, it allows employees to contribute ideas as part of a team. Collective data can also be reviewed by the employees themselves to gain different perspectives, and obtain feedback. Another feature of the invention is the online collaboration process which allows individuals from any organization to come online and provide their personal input to a larger group issue. The end results are satisfied employees performing to their potential and uniquely contributing to the organization. The organization, in turn, is successfully competing in a changing world.

### SUMMARY OF THE INVENTION

The present invention discloses a real-time web-based employee appraisal system and methods for optimizing cooperation, communication, and performance in a business environment. The system provides several online tools for engaging individuals and can be customized to many different individual or business needs. Included is a means for querying via questionnaires regarding personal and company related topics. Employees input responses regarding their personal life, career and work environment and complete an online assessment. This information may then be compiled, analyzed, and utilized by management to provide an improved work environment. The system also contains additional querying tools that focus on helping individuals understand themselves and enabling individuals to increase their effectiveness in their personal lives as well as at work. These tools focus on career success, job search, professional network, family, friends, community etc., and can help people manage their lives outside the business environment. The system can further be used to facilitate teamwork across an organization or collaboration across organizations creating a “virtual enterprise.” Individual employees can contribute their ideas, view individual or collective input, and provide feedback. This helps them work together and create a shared vision for business success.

From the employee's perspective, the system is accessed via the Internet or other form of online network. Advantageously, an online system can facilitate communication between employees or managers in disjointed locations. Preferably, one or more accounts are created for each employee with an identification name and password. Upon accessing the system, employees can respond to a series of questionnaires regarding various personal and company characteristics. For example, the system may incorporate, but is not limited to, the following topics: reputation, performance, potential, finance, recognition, work-life, leading edge, critical work, challenge, personal growth, diversity, leadership, management, professionalism, and fun. Within each section, one or more questionnaires can be implemented. For example, the leadership section may include two questionnaires entitled “The Leadership Challenge” and “Communication That Counts.” The first questionnaire may incorporate questions related to leadership positions and the employee's assessment of his leadership qualities, leadership goals, and steps to meet those goals. The second may comprise questions related to the quality of communication between management and employees.

Through use of questionnaires, employees can communicate personal and work goals. Also, the initial completion of the questionnaires allows employees to assess aspects in which they excel and aspects in which they need improvement, facilitating personal discovery. Employees can reevaluate themselves, keep a journal (online or otherwise), and thereby track their progress by re-completing the questionnaires. The results can be updated and recompiled any number of times.

The questionnaire responses may be compiled into and analyzed in one or more databases. Managers may access the database(s) to ascertain the goals, needs, and opinions of the employees. With this information, managers can then determine what aspects of the company and its work-environment need improvement, and thereby increase productivity and employee satisfaction.

Additionally, the compiled information apprises managers of individual employee's concerns and goals. Using this information, managers can determine an employee's abilities, problems, confidences, and doubts in certain areas. Based on such determinations, managers can devise a tailored, and thus optimal, training program for their subordinates.

Furthermore, employee input can be used to facilitate teamwork or project management across an organization. Contributions by individual employees can be shared with other team members in order to gain unique perspectives and feedback. The individual responses of employees can then be compiled and viewed collectively to create a shared perspective. In this situation, the data input by individual employees could be compiled and stored into a database for review by other employees or members of a project team. Preferably, accessing the database would require a login identification and password. Employees may review input from other employees not necessarily in the same office or location and this system allows them to share ideas. Results may be displayed as individual or collective input for review by the other employees or members of the team. Employees could then enter a rating or give feedback on the compiled results. This method allows employees to recognize the contributions of others and gain different perspectives. Additionally, managers may then review the final compilation of results and provide their feedback. Thus, the system would improve the efficiency of project management and performance of teams.

For example, the system provides tools, including but not limited to, topics such as “Help Our Customers Sleep”, “Grow Competencies” and “Create a Shared Vision.” Individual employees answer free response questions that allow them to focus on achieving business results. The first topic may involve, for example, questions addressing customer concerns, reasons, results, and what the employee and company can do to help. The second topic may, for example, involve questions addressing what strengths and competencies exist in the company, the contributions to success, and how to sustain and use them to differentiate the organization in the marketplace. Responses from all employees are then compiled into a database. Employees can view a collection of responses, other individual employee responses, and their own responses. Employees can then rate the total compiled list, provide feedback, and the manager can access the database to pull together a shared team view.

Additionally, this system is not limited to employee/manager relationships but can be implemented across all levels of an organization. This includes, but is not limited to, employee/employee, middle-level management/upper-level management, and manager/executive. Managers could use the system to communicate and input ideas to their supervisors or upper-management, and so forth up through executives.

The system can further be implemented across different organizations to provide integrated solutions through an online collaboration process, creating a “virtual enterprise.” This feature allows individuals from any organization to access the online system to provide their personal input to a larger group issue. This tool can be used for creating a vision, defining customer requirements, getting feedback from customers and partners, etc., giving businesses a competitive advantage by delivering value to customers.

Alternatively, the system of the present invention can be used by individuals not part of an organization to help manage their careers, professional lives and personal lives using the online tools that help build a professional network, create a supporting environment of family and friends, help others make a difference, achieve a vision of long term career success, etc.

Thus, it is an objective of the present invention to create one or more databases of employee questionnaires and answers for management purposes.

It is another objective of the present invention to provide an enterprise management system for optimizing management practices.

Another objective of the present invention is to provide a means for personal employee and company assessment.

An additional objective of the present invention is to include means for presenting questionnaires through the Internet.

Yet another objective of the present invention is to include a series of questionnaires concerning personal and business related topics.

Still another objective of the present invention is to include numerous questionnaires related to a variety of topics such as company, rewards, work, and people.

Another objective of the present invention is to provide managers with online real-time quantitative and qualitative data about their group by demographics.

Another objective of the present invention is to expedite communication between managers (or supervisors) and their employees.

Another objective of the present invention is to expedite communication between team members of an organization.

Another objective of the present invention is to expedite communication between middle-level management, upper-level management, and executives.

Another objective of the present invention is to facilitate communication between employees, managers, and other organizational members located in different offices or locations.

Yet another objective of the present invention is to allow individuals across organizations to collaborate online and provide their personal input.

Another objective of the present invention is to allow organizations to operate as “virtual enterprises.”

Another objective of the present invention is to deliver value to customers through an integrated solution based from multiple suppliers.

Another objective of the present invention is to gain different perspectives, unique contributions, and feedback from individual employees regarding business concerns.

Another objective of the present invention is to provide one or more databases that store employee input.

Another objective of the present invention is to facilitate analysis such as statistical analysis of employee input.

Yet another object of the present invention is to provide guidance with employee training.

Yet another objective of the present invention is to reduce the gap between employees desired and actual states.

Moreover, it is an objective of the present invention to increase employee self-awareness, facilitate personal discovery, and develop new mindsets for a constantly changing environment.

Additionally, it is an object of the present invention to give organizations a competitive edge and help them effectively compete in a constantly changing market.

Further, it is an objective of the present invention to provide an integrated, online process that can be quickly and easily adapted to many different business needs through customized tools.

These and other objectives will become apparent to one skilled in the art after review of the following figures and claims.

### BRIEF DESCRIPTION OF FIGURES

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 is a flowchart depicting an overview of the online employee assessment and management evaluation process of the preferred embodiment of the present invention.

FIG. 2 is a flowchart illustrating the preferred process of ranking, grading, and commenting on one or more categories in the preferred embodiment of the present invention.

FIG. 3 is a table entitled “The Scorecard” displaying a preferred list of categories with exemplary rankings, grades, and commentary.

FIG. 4 is a flowchart disclosing the preferred process of completing exemplary questionnaires of the preferred embodiment of the present invention.

FIG. 5A depicts a graphical presentation of “The Greatplace™ Model,” an example of the possible areas and categories in the preferred embodiment of the present invention.

FIG. 5B is a table entitled “The Greatplace™ Model” displaying an exemplary list of areas, categories, and types of questions.

FIG. 6 is a table entitled “The Greatplace Journey” depicting an exemplary list of areas, categories, questionnaires, and learning points.

FIG. 7 is a table entitled “Personal Journal” presenting exemplary questionnaire information for employee review.

FIG. 8 is an exemplary table entitled “Compiled Employee Information” presented for analysis by a manager or supervisor.

FIG. 9 is an exemplary table entitled “Help Our Customers Sleep” presented for analysis by a manager or supervisor.

FIG. 10 shows exemplary results of individual employee input presented for analysis by a manager or supervisor.

FIG. 11 is a roll-up of exemplary vision statements from employees presented for analysis by a manager or supervisor.

FIG. 12 shows an exemplary “Online Collaboration Tool” including the three step process for creating a shared vision across organizations.

### DETAILED DESCRIPTION OF THE PREFERRED EMBODIMENTS

A further understanding of the present invention can be obtained by reference to a preferred embodiment as set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, but merely to clarify and exemplify the invention.

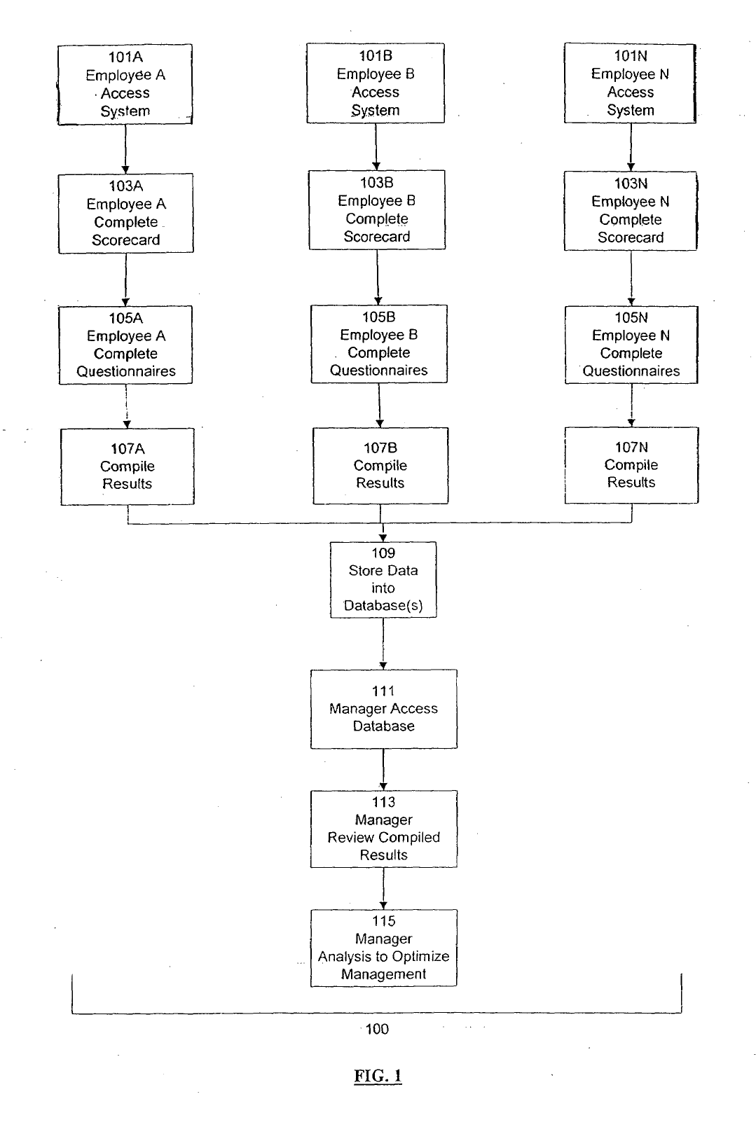

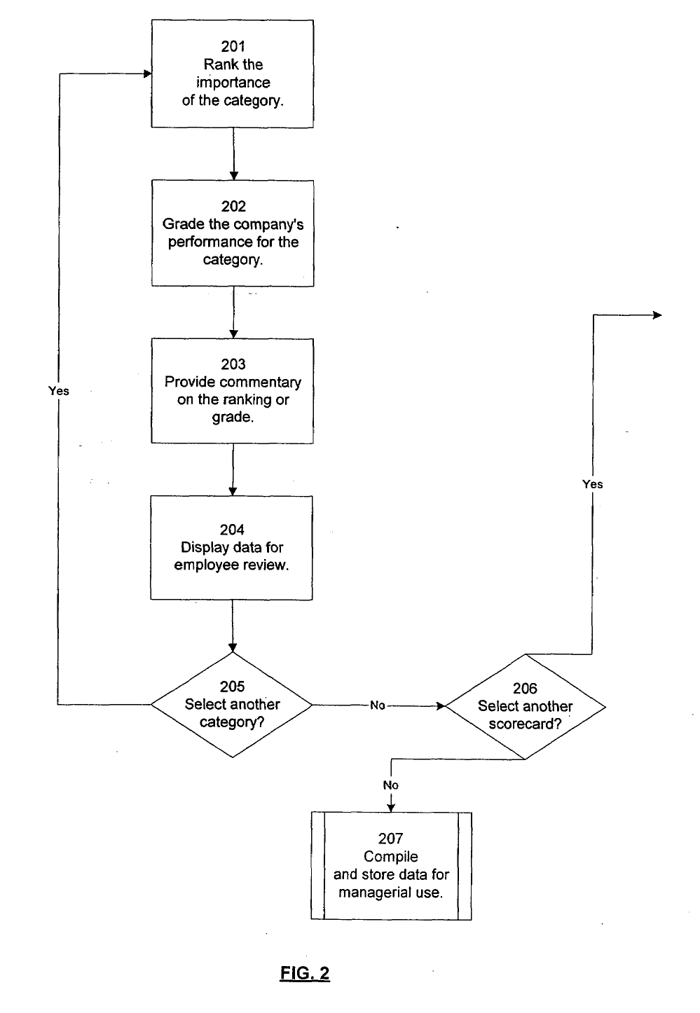

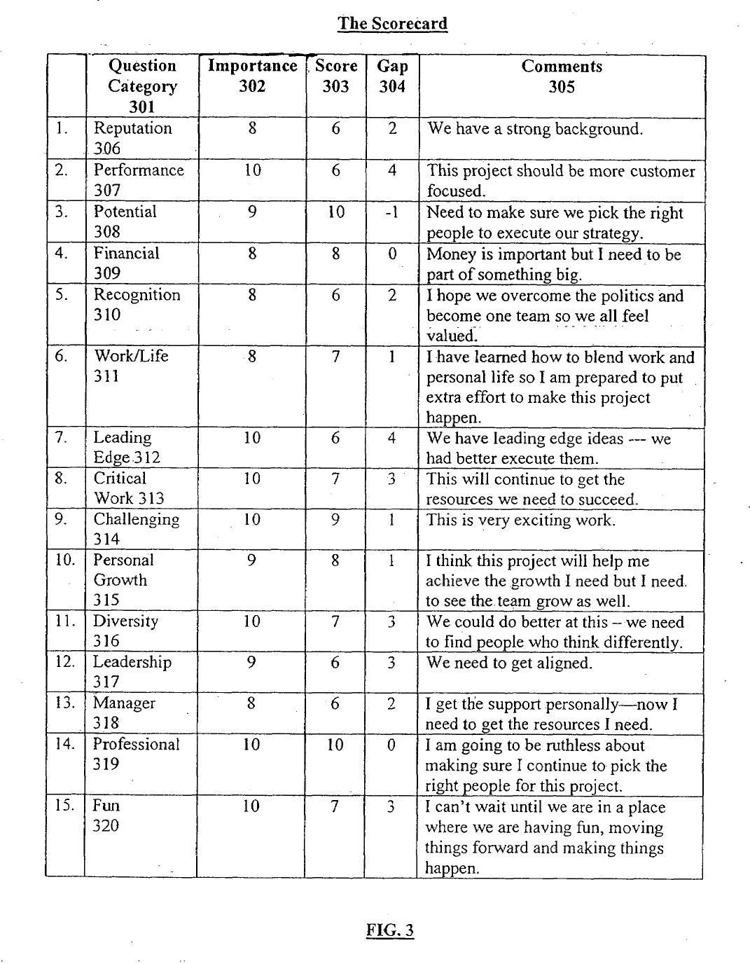

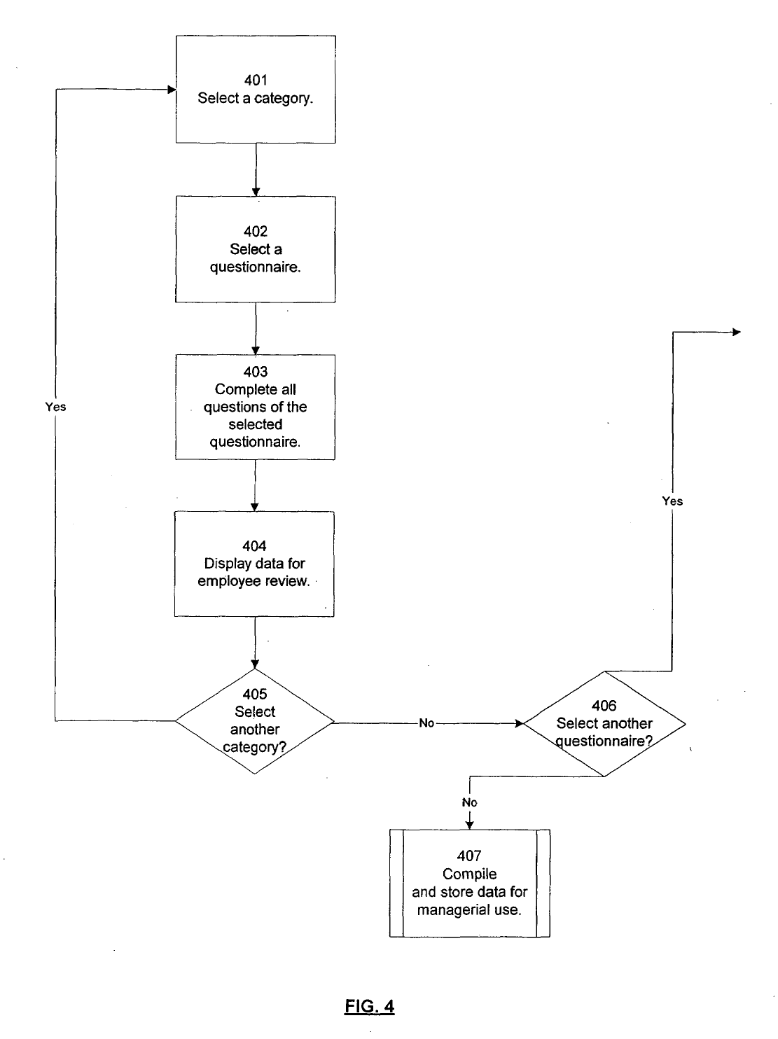

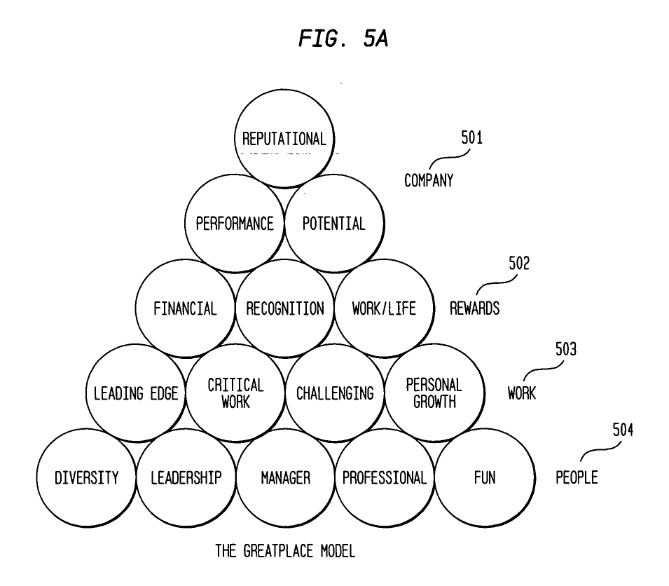

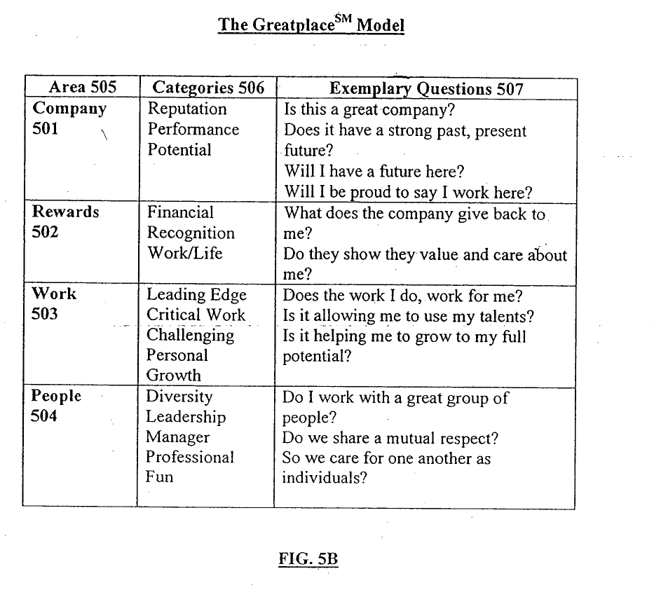

FIG. 1 is a flowchart representing the overall process of the online employee assessment and improved management system in accordance with the preferred embodiment of the present invention. Initially, Employee A accesses the system at step 101A. Preferably, the system is accessed online and access requires that a user name and password are inputted. Also, the system is preferably equipped with means to receive and send online transmissions to one or more databases. Such means include, but are not limited to, coaxial cable, cable modem, fax modem, wireless modem, DSL modem, Ethernet cable, etc. Upon accessing the system, Employee A completes the scorecard at step 103A (which is more fully described infra with reference to FIGS. 2 and 3) and completes the questionnaires at step 105A (which are more fully described infra with reference to FIGS. 4 and 5). The results from Employee A are then compiled at step 107A. Likewise, Employee B follows a similar procedure: access the system at step 101B; complete the scorecard at step 103B; and complete the questionnaire at step 105B. Similarly, the results are compiled and recorded for Employee B at step 107B. This process is repeated for all employees through Employee N. Like Employees A and B, Employee N accesses the system at step 101N, completes the scorecard at step 103N, and completes the questionnaires at step 105N. The results are compiled and recorded for Employee N at step 107N. While the preferred embodiment of the present invention orders step 103A, 103B, and 103N before step 105A, 105B and 105N respectively, the present invention is not limited to this ordering. Furthermore, any of these steps may be omitted or substituted with alternative querying methods. Subsequently, the compiled and recorded results are stored in one or more databases at step 109. Managers or employee supervisors may access the database at step 111, at any time. Preferably, managers' online access to the database will require login identification and a password for security and confidentiality purposes. Preferably, managers, individual employees and groups of employees are afforded different levels of access specified for their respective position or function. This allows information in the database to be selectively accessible or restricted for different people.

Once the manager accesses the database, the data compiled from the employee input may be displayed so that the manager may review the compiled results at step 113. The manager can then analyze the data to optimize the management process at step 115. Analysis of the data may include, but is not limited to, graphical analysis, qualitative analysis, quantitative analysis or any other analysis feasible for improving work environment and/or productivity of their employees.

The flowchart depicted in FIG. 2 represents the preferred process for completing the scorecard at steps 103A, 103B, and 103N of the preferred overall process 100 of FIG. 1. Typically, the scorecard contains identical questions in an identical format for each employee. Alternatively, the scorecard may be tailored specifically for differing occupational groups or customized to meet the needs of the business, team, individual or organization. In the preferred embodiment, the first step of completing the scorecard is ranking the importance of a category at step 201. The scorecard process then entails grading the performance of the company in that category at step 202. The employees may then provide commentary on their rankings or grade at step 203. The inputted information is subsequently recorded for the employee's own review at step 204. The system may determine if the employee has responded to every category at step 205. If it has not, the system may prompt the employee to respond to another category. If more categories remain, and the employee chooses to respond to another category, the process returns to step 201. Preferably, steps 201 through 205 may then be repeated until every category is completed. After completion of any number of categories, the employee may decide to save the information and exit the system, or move on to another scorecard or questionnaire at step 206. Upon completion of the scorecard, the information is compiled into a “scorecard” format (which is more fully described infra with reference to FIG. 3). The information is then stored in one or more databases at step 207 along with the data provided by other employees. At any time, an employee may repeat the process to monitor individual or company progress. Additionally, an employee may repeat the process to update a scorecard.

The table of FIG. 3 entitled “The Scorecard” depicts an exemplary format for displaying input from a single employee, or alternatively, an averaged input from all employees. In this example, the scorecard comprises five columns. “Question Category” 301 indicates the categories in which the employee(s) are queried. Categories may include, but are not limited to, reputation 306, performance 307, potential 308, financial 309, recognition 310, work/life 311, leading edge 312, critical work 313, challenging 314, personal growth 315, diversity 316, leadership 317, manager 318, professional 319, and fun 320. “Importance” 302 indicates the employee(s) ranking of how important that category is to them. “Score” 303 represents the employee(s) assessment of the company's actual performance in the relevant category. “Gap” 304 is the difference between the values for Importance 302 and Score 303 (i.e., Gap=Importance−Score). Thus, if Importance holds a greater value than Score, Gap is positive. Conversely, if Score's value is greater than Importance, Gap is negative. “Comments” 305 displays the comments that the employee(s) inputted regarding the relevant category, in addition to the corresponding rankings and scores.

FIG. 4 is a flowchart of the preferred process for completing the questionnaires at steps 105A, 105B, and 105N of the preferred overall system 100 of FIG. 1. The first step of completing a questionnaire requires selecting a category at step 401. The categories may be grouped into “areas” for further clarification of the included information. Once a category is selected, one or more questionnaires may be available for each category. The second step of the preferred process is selecting a questionnaire at step 402. Typically, questionnaires are identical for all employees. Alternatively, questionnaires could be tailored specifically for different occupational/employee groups or customized to meet the needs of the individual, team, business or organization. The third step is answering the questions presented in the questionnaire at step 403. These questions may appear in various formats including, but not limited to, multiple choice, ranking, or written answer. Subsequently, the system stores the information for employee review at step 404. The system may ask employees whether they want to select another category at step 405. Alternatively, the system may automatically require an employee to select another category at step 405 until every category has been completed. In the case that the employee decides, or is required, to select another category, steps 401 through 405 are repeated. At any time, the employee may choose to fill out a different questionnaire. Preferably, at the end of each questionnaire, the employee is prompted to fill out another questionnaire at step 406. Otherwise, the inputted information is compiled and stored in one or more databases 407.

FIG. 5A is a representation of the Greatplace™ Model. This is a picture illustrating the preferred categories of the present invention. In the figure, the categories are displayed as circles in the shape of a pyramid. The categories are grouped into areas preferably including: “Company” 501, “Rewards” 502, “Work” 503, and “People” 504. By arranging the categories into areas, their relationships to the company and to each other are clearer.

The table of FIG. 5B lists columns of the preferred areas 505 of the Greatplace™ Model with the corresponding categories 506 and exemplary questions 507. The areas listed include “Company” 501, “Rewards” 502, “Work” 503, and “People” 504 with their corresponding categories 506 and exemplary questions 507. “Company” 501 includes the categories of reputation, performance, and potential. The exemplary questions show what may be asked for each category. “Rewards” 502 includes the categories of financial, recognition, and work/life. Again, exemplary questions are indicated in each category at 506. Preferably, the exemplary questions target the employees' opinions of themselves, the company, and the relationship between them.

Each of the areas of the Greatplace™ Model preferably includes at least one or more questionnaires specified for each preferred category. Each questionnaire preferably includes questions designed to help the employee achieve a “learning point.” Learning points are preferably designed to help employees realize what they need to fully contribute to the organization, focus on their goals, and effectively deliver results. The learning points preferably assist employees in building their confidence and commitment, as well as accountability.

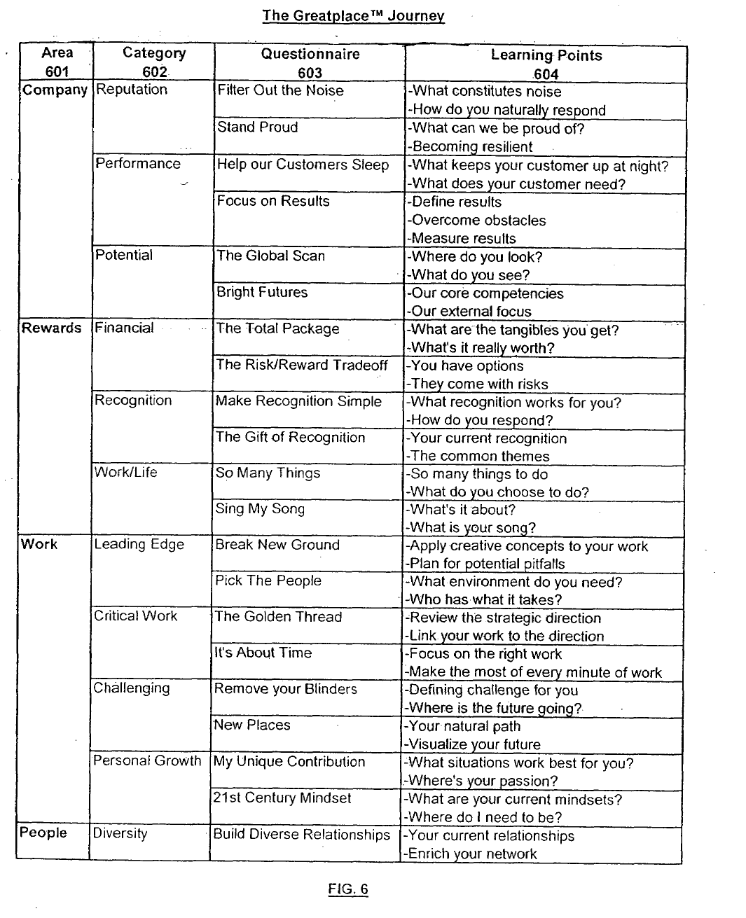

FIG. 6 is an expanded view of the Greatplace™ Model in table form listing “Areas” 601 and corresponding “Categories” 602 of the Greatplace™ Model, with corresponding exemplary “Questionnaires” 603 and exemplary “Learning Points” 604. For example, the first section “Company” has three categories, reputation, performance, and potential. Each of the categories has related questionnaires. For example, the “Performance” category has two questionnaires entitled “Focus on Results” and “Help Our Customers Sleep.” Corresponding learning points 604 are displayed for each questionnaire 603. Learning points are the aspects focused on by each questionnaire. The learning points for the questionnaire entitled “Focus On Results” are “Define Results,” “Overcome obstacles,” and “Measure Results.”

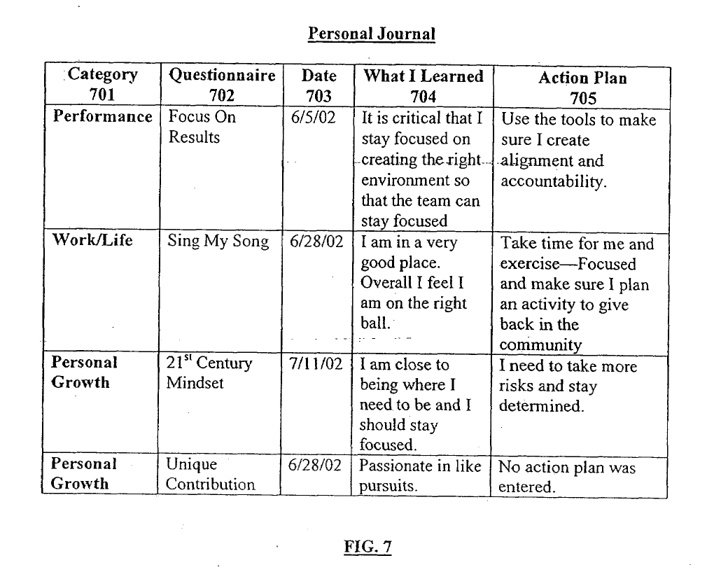

The final step, on the employee side, of the preferred overall process 100 of FIG. 1 is compiling and recording the results at steps 107A, 107B, and 107N. The results may be compiled in a format entitled “Personal Journal,” shown in FIG. 7, which is preferably accessed only by the individual employee. The “Personal Journal” may contain any portion of the completed questionnaires of steps 105A-105N of the preferred overall process 100 of FIG. 1. It may present a brief summary of the results of each questionnaire, including information such as what was learned, action plans, and the date completed.

FIG. 7 is a table entitled “Personal Journal” presenting a portion of the compiled employee input. The columns of the table are entitled “Category” 701, “Questionnaire” 702, “Date” 703, “What I Learned” 704, and “Action Plan” 705.

Additionally, the “Personal Journal” allows the employee to view a full summary of completed questionnaires, and optionally, update answers. The format of the “Personal Journal” may be selected to show different results of the completed questionnaires. For instance, the completed questionnaire results may display a summary of what was learned from the questionnaire, a summary of the action plan, or both. Further, the results of the completed questionnaires may be sorted by a number of factors including, but not limited to, date, questionnaire name, or category.

Once all of the employee data has been collected and compiled, it is stored in the database at step 109 of the overall process 100 in FIG. 1. Managers (or supervisors) can access the data to gain understanding of the individual and overall sentiments of their workforce (shown as steps 111, 113, and 115 in FIG. 1). As in the data collection process, analysis of the results should not significantly disrupt workflow or productivity. Therefore, preferably, the steps of analysis are completed by the present invention before the results are displayed to management. Moreover, the output format is optimized to require minimal time and effort for interpretation of the results. Simply put, the present invention is designed to do as much work as possible for managers prior to managerial review of the employee data.

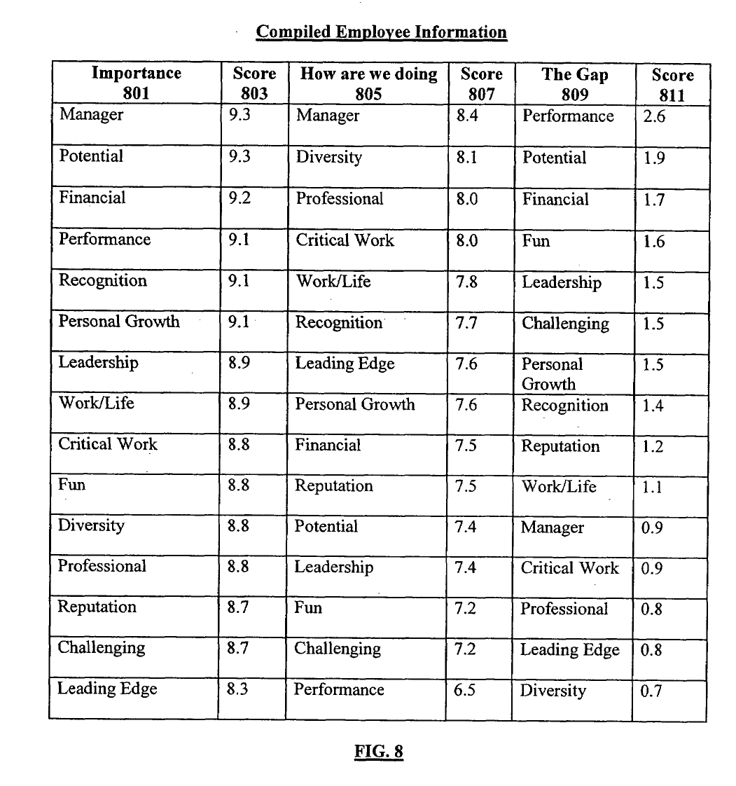

A possible output format for the collective completion of the scorecard shown in FIG. 3 (and also steps 103A, 103B, and 103N of FIG. 1) is a “results report” shown in FIG. 8. The average values for “Importance” 801, “How Are We Doing” 805, and “The Gap” 809, are shown under “Score” 803, “Score” 807 and “Score” 811, respectively, for each of the factors. The results are calculated from all scorecards completed within the specified time period, and displayed in descending order based on score. Comments 305 input on the scorecard in FIG. 3 may be viewed by clicking onscreen next to the desired factor in FIG. 8. The compiled employee info of FIG. 8 allows managers to view quantitative data and provides them with information about what is most important to whom, what is effective, and what is being learned. The manager may also manipulate data using other tools such as statistical programs and graphs for further analysis.

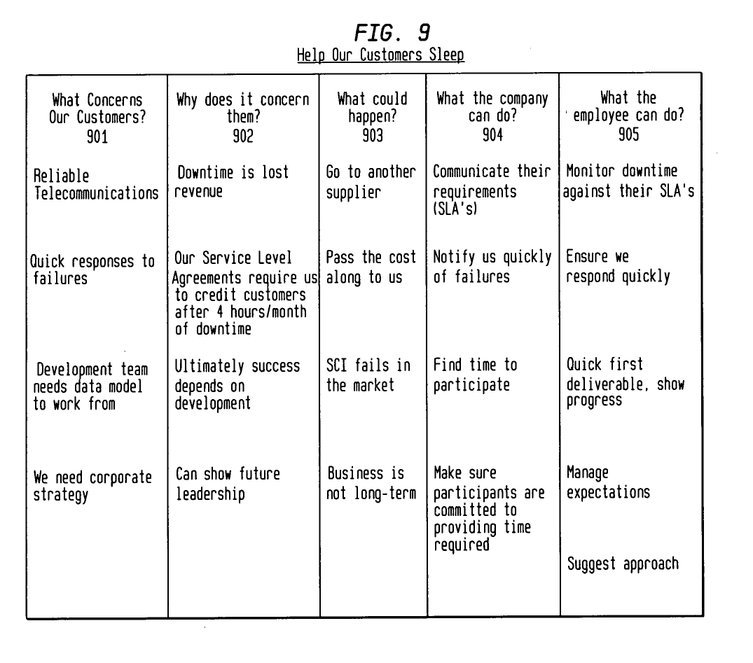

One possible output format for completion of questionnaires (steps 103, 107, and 111 of FIG. 1 and the contents of FIGS. 4 and 5B) is the compiled list format shown in the table of FIG. 9. Here, the employee's evaluation of a certain aspect of the company, and the corresponding effects and suggestions are listed. This table shows the results of the questionnaire entitled “Help Our Customers Sleep.” In this exemplary questionnaire, employees answer questions geared toward increasing performance. The employee answers are compiled and displayed in a column list for the corresponding questions “What Concerns Our Customers” 901, “Why Does It Concern Them” 902, “What Could Happen” 903, “What the Company Can Do” 904, and “What the Employee Can Do” 905. Because the number of employees polled can be quite large, search and sort features may be implemented for efficient review of the results.

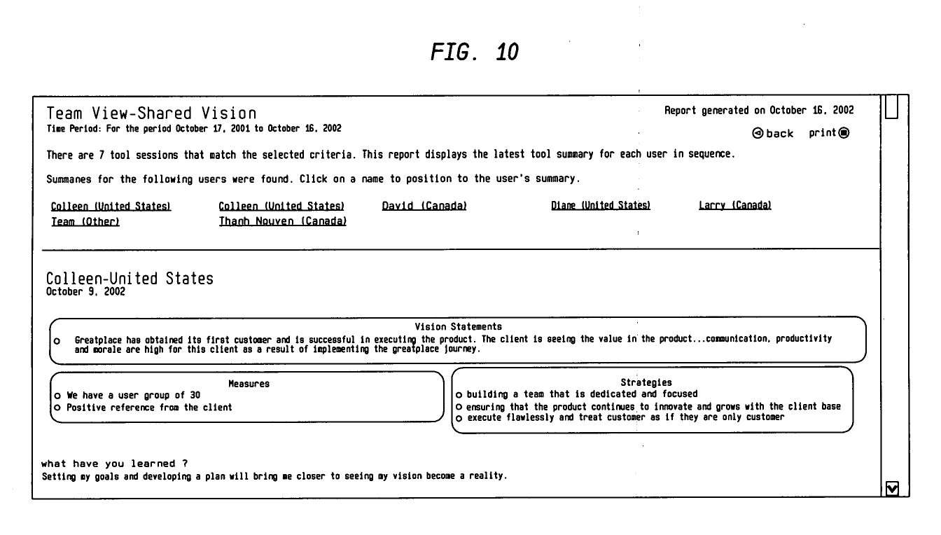

Additionally, managers can review the results of individual employees. Such results may be displayed as shown in FIG. 10. Here, the answers given on a particular questionnaire are listed by each employee. Preferably, the manager can jump to any employee by clicking a link or inputting an employee's name. The results for that employee are then displayed. The top portion of the screen in FIG. 10 shows the list of employees that have responded to the questionnaire entitled “Shared Vision.” To view, for example, the response summary of Colleen, preferably, the user will click on the name “Colleen” in the top portion of the screen. The individual results for Colleen are then displayed as shown in the bottom half of the screen in FIG. 10. Specifically, Colleen's responses for this questionnaire include vision statements, measures and strategies.

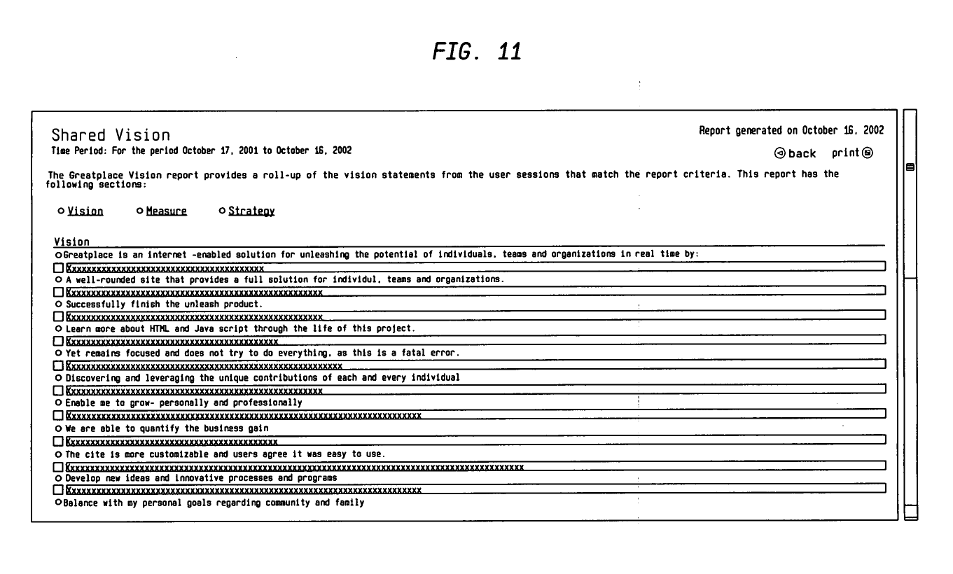

Also, a compiled roll-up list separated by category may be displayed. An example of such a list is disclosed in FIG. 11. Therefore, the inputs from all employees' given on a specific topic may be compiled into a single list. In this figure, the topic entitled “vision” is displayed with corresponding employee responses. The list may be searched to find employees views on even more specific areas using search and sort features. Moreover, the list may be sorted (although not shown in this figure) based on how the employee has prioritized each input, an employee's standing in the company, or any other useful criteria. Therefore, all employees' views adopted on a specific topic can be quickly and easily analyzed by management.

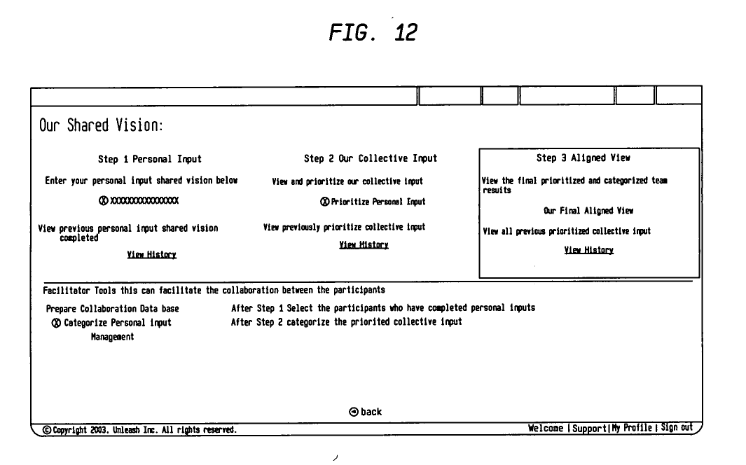

Similarly, the system of the present invention could be used to allow individuals from any organization to come online and provide their personal input to a larger group issue in an online collaboration process. A solution to customer needs can come through an integrated solution based from multiple suppliers or organizations. Referring to FIG. 12, shown is an exemplary “Online Collaboration” tool for creating one aligned view. This tool can be used for creating a vision, defining customer requirements, getting feedback from customers and partners, etc. FIG. 12 shows the three step process for creating a shared vision. The steps involve entering personal input to the shared vision, viewing and prioritizing the collective input, and finally, prioritizing and categorizing the team results to create an aligned view.

While the present invention has been described with reference to one or more preferred embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention.

I claim:

1. A method for optimizing performance comprising the steps of:
providing at least one online questionnaire to at least one individual;
compiling results of said at least one questionnaire into at least one database;
displaying said results of said at least one questionnaire; and
applying said results of said at least one questionnaire for said optimizing.

2. A method according to claim 1, wherein said providing is facilitated by at least one network.

3. A method according to claim 2, wherein said network is selected from the group consisting of an internet, an intranet, a wireless network, a cellular network, a wide area network, a local area network, a virtual private network, a token ring network, and a dial-up network.

4. A method according to claim 1, further comprising the step of chronologically tracking the progress of said results.

5. A method according to claim 1, further comprising the step of displaying said results in real-time.

6. A method according to claim 1, wherein said results are displayed online.

7. A method according to claim 1, wherein at least part of said results of said individual are displayed to at least one person other than said individual.

8. A method according to claim 1, wherein said results displayed vary depending on the person viewing said results.

9. A method according to claim 1, wherein said at least one database requires authorized access.

10. A method according to claim 1, wherein at least part of said results is sorted.

11. A method according to claim 1, wherein at least part of said results is statistically analyzed.

12. A method according to claim 1, wherein at least part of said results is summarized.

13. A method according to claim 1, further comprising the step of quantitatively analyzing said results.

14. A method according to claim 1, further comprising the step of qualitatively analyzing said results.

15. A method according to claim 1, wherein said questionnaire comprises at least one question, said question being in a format selected from the group consisting of multiple-choice, ranking, and written answer.

16. A method according to claim 1, further comprising the step of providing said individual with suggestions, help or tools for improvement.

17. A method according to claim 1, wherein said performance comprises individual performance.

18. A method according to claim 1, wherein said performance comprises business performance.

19. A method according to claim 1, wherein said performance comprises team performance.

20. A method according to claim 19, wherein said team performance comprises at least one selected from the group consisting of innovation, engagement, alignment, productivity, and collaboration.

21. A method according to claim 1, wherein said individual is a member of an organization.

22. A method according to claim 21, wherein said at least one questionnaire is customized for said organization.

23. A method according to claim 1, wherein said at least one questionnaire is customized for said individual.

24. A method according to claim 1, further comprising the step of determining the gap between said individual's desired state and said individual's actual state.

25. A method according to claim 21, wherein said performance comprises employee and management performance within said organization.

26. A method according to claim 21, further comprising the step of displaying at least part of said results to at least one member of a different organization.

27. A method according to claim 26 wherein said organization is part of a “virtual enterprise.”

28. A method according to claim 21, wherein said questionnaire comprises questions on topics selected from the group consisting of self appraisal, appraisal of said organization, project goals, customer service, work environment, leadership, communication, educational programs, personal goals, ideas, perspectives, feedback, and relationships.

29. A method according to claim 21, wherein at least part of said results of said member are displayed in a format containing at least one of category, importance, score, gap, and comments.

30. A method according to claim 1, wherein said optimizing comprises the step of improving said individual's work environment.

31. A method according to claim 1, wherein said optimizing comprises the step of creating a shared view.

32. A method according to claim 1, wherein said optimizing comprises the step of obtaining feedback.

33. A method according to claim 21, wherein said performance comprises the performance of a “virtual enterprise”, wherein said organization is part of said “virtual enterprise.”

34. An apparatus comprising:
questionnaire means for providing at least one online questionnaire designed to be completed by at least one individual;
compilation means for compiling results of said questionnaire; and
at least one database, wherein said results are stored;
wherein said results can be used to optimize performance.

35. An apparatus according to claim 34 further comprising a security means, said security allowing a level of access to said results depending on the person accessing said results.

36. An apparatus according to claim 34 further comprising connection means for connecting said apparatus to a network.

37. An apparatus according to claim 36, wherein said connection means is selected from the group consisting of internet connection, intranet connection, cable modem, fax modem, DSL modem, coaxial cable, and telephone line.

38. An apparatus according to claim 34, wherein said questionnaire means and said database are connected by connection means.

39. An apparatus according to claim 38, wherein said connection means is selected from the group consisting of internet connection, intranet connection, cable modem, fax modem, DSL modem, cellular modem, coaxial cable, and telephone line.

40. An apparatus according to claim 34, further comprising display means for displaying at least part of said results.

41. An apparatus according to claim 34, further comprising statistical analysis means for statistically analyzing at least part of said results.

42. An apparatus according to claim 34, further comprising chronological tracking means for chronologically tracking progress of said results.

43. An apparatus according to claim 34, wherein said results are displayed in real-time.

44. An apparatus according to claim 34, wherein said results are displayed online.

45. An apparatus according to claim 34, further comprising display means for displaying at least part of said results to at least one person other than said individual.

46. An apparatus according to claim 34, wherein said questionnaire comprises at least one question, said question being in a format selected from the group consisting of multiple-choice, ranking, and written answer.

47. An apparatus according to claim 34, wherein said at least one questionnaire is customized for said individual.

48. An apparatus according to claim 34, wherein said at least one questionnaire is customized for an organization.

49. An apparatus according to claim 34, further comprising means for displaying at least part of said results of said individual in a format containing at least one of category, importance, score, gap, and comments.

50. A method for optimizing employee and management performance within an organization comprising the steps of:
providing at least one online questionnaire to at least one member of said organization;
compiling results of said at least one questionnaire into at least one database;
displaying said results of said at least one questionnaire; and
applying said results of said at least one questionnaire for said optimizing.

51. A method for optimizing team performance within an organization comprising the steps of:
providing at least one online questionnaire to at least one team member of said organization;
compiling results of said at least one questionnaire into at least one database;
displaying said results of said at least one questionnaire; and
applying said results of said at least one questionnaire for said optimizing.

52. A method for optimizing the performance of organizations comprising the steps of:
providing at least one online questionnaire to at least one member of said organization;
compiling results of said at least one questionnaire into at least one database;
displaying said results of said at least one questionnaire; and
applying said results of said at least one questionnaire for said optimizing.
